(19) United States
(12) Patent Application Publication
(10) Pub. No.: US 2010/0207955 A1
(43) Pub. Date: Aug. 19, 2010

(54) VIDEO DISPLAY APPARATUS

(75) Inventors: Noriyuki NISHIMAKI, Kawasaki (JP); Toshio Ueda, Kawasaki (JP)

Correspondence Address: MILES & STOCKBRIDGE PC, 1751 PINNACLE DRIVE, SUITE 500, MCLEAN, VA, 22102-3833, US

(73) Assignee: HITACHI PLASMA DISPLAY LIMITED

(21) Appl. No.: 12/691,546

(22) Filed: Jan. 21, 2010

(30) Foreign Application Priority Data
Jan. 23, 2009 (JP) 2009-012485

(51) Int. Cl. G09G 5/02

(52) U.S. Cl. 345/589

(57) ABSTRACT

In a display apparatus such as PDP, in order to obtain well-lighted video while suppressing an increase in power consumption, the luminance level of a specific region of a display panel is decreased in accordance with an average luminance level of the entire display panel. However, when a low-luminance region and a high-luminance region are mixed in display video, even the luminance of the low-luminance region is decreased and gray-scale crush is caused in some cases. An average luminance level for each region is detected, and a shading process is controlled for each region based on the detected region-specific average luminance level and the luminance level of input video. With this control, when the luminance level of the input video signal is higher than a predetermined threshold, the shading process is operated, and when the luminance level is lower than the predetermined threshold, the shading process is stopped.

### CROSS-REFERENCE TO RELATED APPLICATION

The present application claims priority from Japanese Patent Application No. JP 2009-012485 filed on Jan. 23, 2009, the content of which is hereby incorporated by reference into this application.

### TECHNICAL FIELD OF THE INVENTION

The present invention relates to a video display apparatus including a display panel, and more particularly to a video display apparatus suitable for obtaining well-lighted video while suppressing an increase of power consumption of a display panel of a self-luminous type such as a plasma display panel (hereinafter referred to as PDP).

### BACKGROUND OF THE INVENTION

Compared with display apparatuses using CRT or LCD, PDP display apparatuses have a low white luminance as a whole, and therefore have a low contrast (bright-room contrast) in a bright living room in the daytime or the like. To increase a display luminance, the number of discharge pulses for driving the PDP or its driving voltage is increased. In this case, however, the problem of increase in power consumption occurs.

As a conventional technology for solving such a problem in the PDP display apparatus as described above, that is, for increasing the brightness of video while suppressing power consumption, a process of decreasing the luminance of a screen peripheral portion more than the luminance of a screen center portion has been known (hereinafter, such a process is referred to as a “shading process”, and a circuit for performing the shading process is referred to as a “shading circuit”).

A shading operation is now described with reference to FIGS. 2A to 2C. FIGS. 2A to 2C depict an example of a decrease ratio of a luminance level at the time of a shading operation when displayed video is entirely white. FIG. 2A depicts pixel positions on a display panel, in which coordinates in a horizontal direction are X and coordinates in a vertical direction are Y. In FIG. 2B, the vertical axis represents a pixel position in a vertical direction, and the horizontal axis represents a ratio of an input video signal after a shading operation with respect to a luminance level, in which a decrease ratio of the luminance level of an output video signal is gradually increased from the screen center portion to the screen peripheral portion.

In FIG. 2C, the vertical axis represents a ratio of an input video signal after a shading operation with respect to a luminance level, and the horizontal axis represents a pixel position in a horizontal direction, in which a decrease ratio of the luminance level of an output video signal is gradually increased from the screen center portion to the screen peripheral portion similarly to FIG. 2B. Note that multiplying a luminance decrease ratio on the X axis by a luminance decrease ratio on the Y axis yields an actual luminance decrease ratio at a pixel corresponding to the respective coordinates. Examples of the above-described conventional technology using a shading operation are disclosed in Japanese Patent Application Laid-Open Publications No. 6-282241 and No. 2002-55675.

In Japanese Patent Application Laid-Open Publications No. 6-282241 and No. 2002-55675, the shading process utilizes human visual characteristics that it is difficult to visually notice the difference even when luminance of a screen peripheral portion of well-lighted video with a high luminance level is decreased. The visual characteristics as mentioned above are derived from the fact that the human sense of sight has a so-called logarithmic characteristic with respect to brightness. In the shading process, a decrease in luminance of the screen peripheral portion is used for an increase in luminance of the screen center portion. By this means, when well-lighted video is displayed, an appearance of video brightness is increased while preventing visual discomfort and suppressing power consumption.

As another example of the conventional technology, Japanese Patent Application Laid-Open Publication No. 2005-321664 discloses a video processing apparatus capable of efficiently controlling a shading circuit and displaying high-quality video while suppressing an increase in power consumption.

In this example, an average luminance level of the entire display panel is detected, and the shading operation is controlled in accordance with the detected average luminance level. More specifically, when well-lighted video (high-luminance video) is displayed, the shading circuit is operated to suppress an increase in power consumption, and when low-lighted video (low-luminance video) is input, the shading operation is stopped to prevent the deterioration in image quality (gray-scale crush).

### SUMMARY OF THE INVENTION

In Japanese Patent Application Laid-Open Publication No. 2005-321664, the shading operation is controlled in accordance with the average luminance level of the entire display panel. In this case, for example, when a video signal with a low-luminance region 10 and a high-luminance region 11 mixed together as depicted in FIG. 3A is input and the shading process is operated because an average luminance level of an entire region on the display panel is high, the shading process is uniformly performed also for the low-luminance region 10. Therefore, in the low-luminance region 10 of a peripheral portion, the luminance is further decreased due to shading, which invites the gray-scale crush.

More concrete example is described with reference to FIGS. 3B and 3C showing a relation between a pixel position and a luminance level in a screen peripheral portion 12 in FIG. 3A. When a shading process for decreasing the input video luminance level of FIG. 3B from the screen center portion to the peripheral portion is operated, the luminance level is decreased as depicted in FIG. 3C. Here, according to the comparison of FIGS. 3B and 3C as to a relatively low-luminance region between X₋₄Y₋₄ and X₋₃Y₋₄, since the luminance level of a part of the region is below a predetermined threshold in FIG. 3C, gray-scale crush occurs in the screen peripheral portion, and video image is displayed as black.

In actual displayed video, the possibility that such a video signal (video in which well-lighted video and low-lighted video are mixed together) is input is extremely high, and there is concern for causing the deterioration in image quality.

Moreover, in Japanese Patent Application Laid-Open Publication No. 2005-321664 in which the shading operation is controlled in accordance with the average luminance level of the entire display panel, for example, when a video signal in which an average luminance level of only one color among R, G and B making up pixels is high and average luminance levels of the other colors are low is input, the average luminance level of the entire display panel does not reach the threshold, and therefore the shading process is not operated. For this reason, there is a problem that an increase in power consumption cannot be suppressed.

The present invention has been devised in view of the problems described above. An object of the present invention is to provide a video display apparatus capable of displaying high-quality video while suppressing an increase in power consumption.

To achieve the object above, the video display apparatus according to the present invention is provided with a control circuit that controls a shading circuit in accordance with a state quantity regarding an operation of a display panel such as a PDP.

More specifically, an average luminance level of an input video signal is detected for each display region as a state quantity, and information for decreasing the luminance level of input video (hereinafter referred to as a shading gain coefficient) is calculated from the average luminance level detected for each display region, and furthermore, it is determined whether the luminance level of the input video signal exceeds a predetermined threshold. When the luminance level of the input video signal exceeds the predetermined threshold, the shading circuit is operated based on the calculated shading gain coefficient, and when the luminance level is lower than this threshold, the operation of the shading circuit is stopped.

According to the present invention, high-quality video can be displayed while suppressing power consumption. In detail, in a high-luminance region where gray-scale crush does not occur in displayed video even when a shading process is performed, the luminance level of the input video is decreased to suppress an increase in power consumption, and in a low-luminance region where gray-scale crush occurs when a shading process is performed, the luminance level of the input video is not decreased to prevent a decrease in video quality. With such control, high-quality video with excellent bright-room contrast can be provided by increasing the luminance of the screen center portion without increasing power consumption.

### BRIEF DESCRIPTIONS OF THE DRAWINGS

FIG. 1 is a diagram of a process flow in an embodiment of the present invention;

FIG. 2A is a diagram for describing a shading process;

FIG. 2B is another diagram for describing the shading process;

FIG. 2C is another diagram for describing the shading process;

FIG. 3A is a diagram for describing a problem at the time of a shading operation in a conventional technology;

FIG. 3B is another diagram for describing the problem at the time of the shading operation in the conventional technology;

FIG. 3C is another diagram for describing the problem at the time of the shading operation in the conventional technology;

FIG. 4A is a diagram for describing an effect at the time of a shading operation in the present invention;

FIG. 4B is another diagram for describing the effect at the time of the shading operation in the present invention;

FIG. 4C is another diagram for describing the effect at the time of the shading operation in the present invention;

FIG. 5 is a block diagram of a PDP display apparatus according to an embodiment of the present invention;

FIG. 6 is a diagram for describing a shading coefficient averaging circuit in the present invention;

FIG. 7 is a diagram for describing a method of selecting a shading gain coefficient at an arbitrary display point;

FIG. 8A is a characteristic diagram of a luminance level after a shading process according to an embodiment;

FIG. 8B is another characteristic diagram of the luminance level after the shading process according to the embodiment;

FIG. 9A is a characteristic diagram of a shading gain coefficient a according to an embodiment;

FIG. 9B is another characteristic diagram of the shading gain coefficient a according to the embodiment; and

FIG. 10 is a diagram showing segmentalized regions for detecting an average luminance level.

### DESCRIPTIONS OF THE PREFERRED EMBODIMENTS

Preferred embodiments of the present invention will be described below with reference to the drawings. Note that, in each drawing, portions having the same function are denoted by the same reference numerals, and the portions described once are not redundantly described for the sake of brevity.

In the following description, a PDP display apparatus is taken as an example of a video display apparatus. However, the present invention is not meant to be restricted to this and can be applied also to video display apparatuses using a display panel whose power consumption increases in accordance with display load, for example, a display panel of a self-luminous type such as a field emission display (FED), EL or an LED panel provided with LEDs arranged in a matrix.

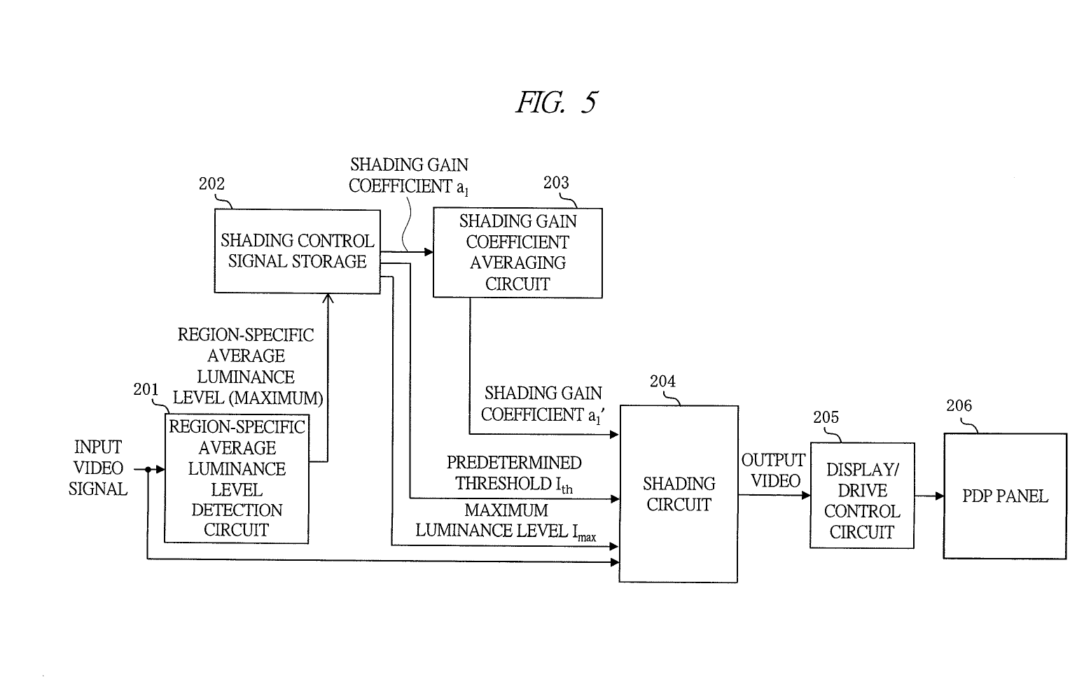

FIG. 5 is a block diagram of a PDP display apparatus according to an embodiment of the present invention. In the drawing, the apparatus includes a region-specific average luminance level detection circuit 201, a shading control signal storage 202, a shading gain coefficient averaging circuit 203, a shading circuit 204, a display/drive control circuit 205, and a PDP panel 206.

The region-specific average luminance level detection circuit 201 and the shading control signal storage 202 are described below.

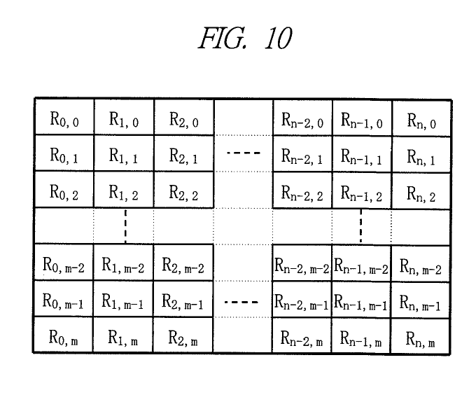

The region-specific average luminance level detection circuit 201 divides pixels on a display panel into n+1 regions in a horizontal direction and m+1 regions in a vertical direction as depicted in FIG. 10, and detects an average luminance level of each of R, G and B making up the pixels in each divided region based on an input video signal. Then, the region-specific average luminance level detection circuit 201 selects a maximum value among the average luminance levels of R, G and B making up the pixels as an average luminance level of each region, and outputs the selected value to the shading control signal storage 202.

Alternatively, as the output from the region-specific average luminance level detection circuit 201, an average value of the average luminance levels of R, G and B may be output to the shading control signal storage 202.

From the shading control signal storage 202, a shading gain coefficient a₁ corresponding to the average luminance level selected for each region is output to the shading gain coefficient averaging circuit 203 as a shading coefficient for pixels corresponding to four corners of each region (hereinafter referred to as “reference pixels”).

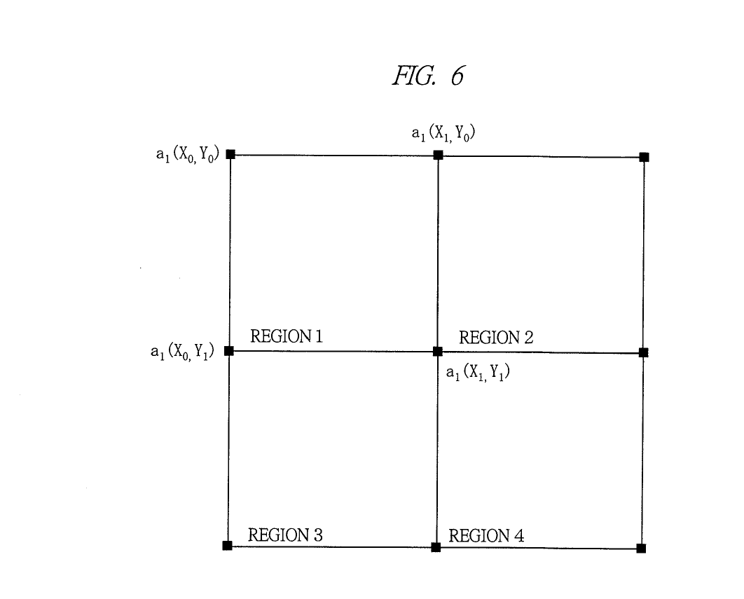

Here, the reference pixels are described with reference to FIG. 6. The reference pixels are set so as to be redundant among a plurality of adjacent regions. For example, (X₁, Y₁) in FIG. 6 is positioned at one of the four corners of regions 1 to 4, and four shading gain coefficients a₁(X₁, Y₁) for (X₁, Y₁) are calculated from the shading control signal storage 202 based on the average luminance level in each region.

These four shading gain coefficients a₁(X₁, Y₁) are averaged by the shading gain coefficient averaging circuit 203, and the resultant value is output as a shading gain coefficient a₁′(X₁, Y₁) for (X₁, Y₁) to the shading circuit 204. Furthermore, to the shading circuit 204, a maximum luminance level Iₘₐₓ, a predetermined threshold Iₜₕ, and an input video signal are output from the shading control signal storage 202. The predetermined threshold Iₜₕ is a decision value for preventing the gray-scale crush of displayed video, and it is initially set as a fixed value and is output to the shading circuit 204.

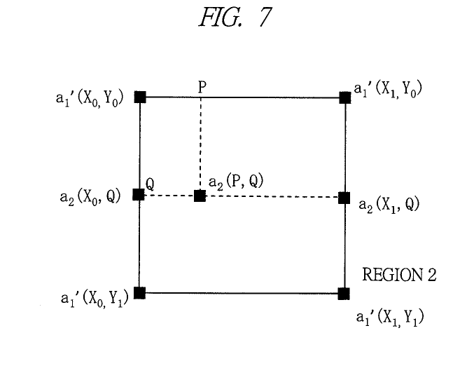

Next, a shading gain coefficient a₂ of arbitrary display coordinates in each region calculated by the shading circuit 204 is described with reference to FIG. 7. The shading gain coefficient a₂(P, Q) is calculated through interpolation from the shading gain coefficients a₁′ of the reference pixels. First, through linear interpolation between two points of the shading gain coefficients a₁′(X₀, Y₀) and a₁′(X₀, Y₁) output from the shading gain coefficient averaging circuit 203 (such linear interpolation is hereinafter referred to as linear interpolation between two points), a₂(X₀, Q) is calculated. Next, through linear interpolation between two points of a₁′(X₁, Y₀) and a₁′(X₁, Y₁), a₂(X₁, Q) is calculated. Then, through linear interpolation between two points of a₂(X₀, Q) and a₂(X₁, Q), a₂(P, Q) is calculated. Thereafter, a shading gain coefficient corresponding to each pixel in each region is calculated in the same manner. This is for the purpose of reducing the storage capacity of the shading control signal storage 202, and shading gain coefficients corresponding to all display coordinates of the input video signal may be stored in the shading control signal storage 202.

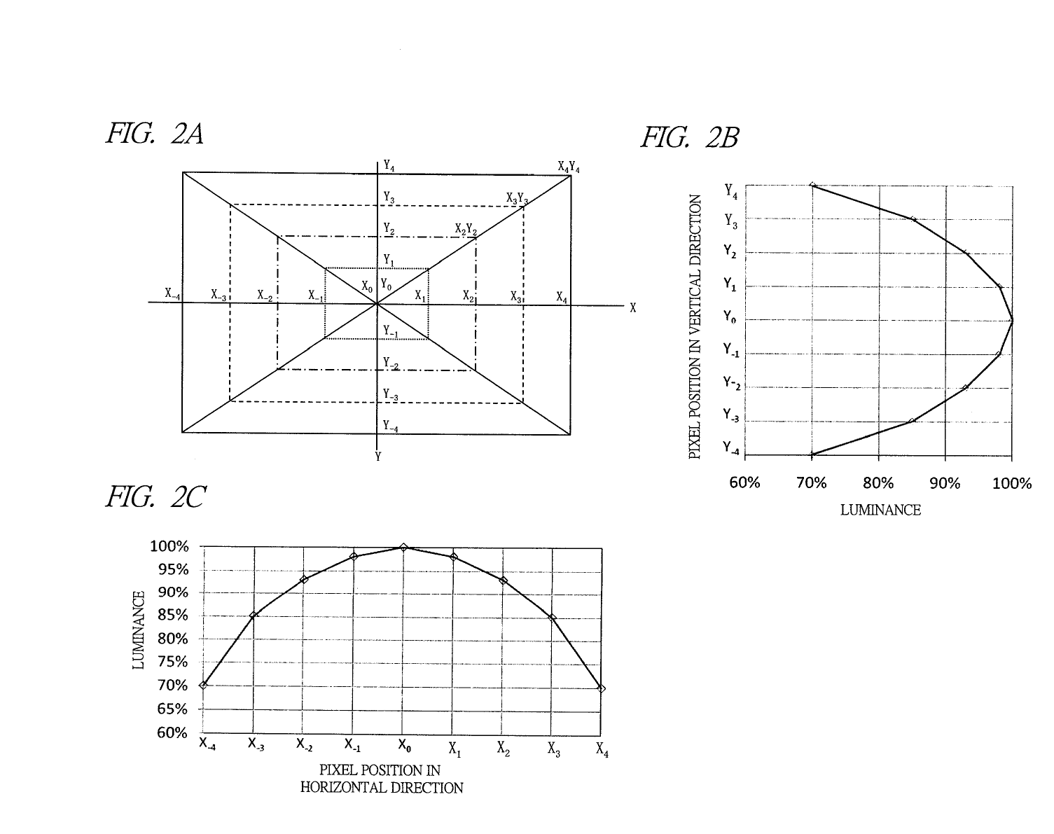

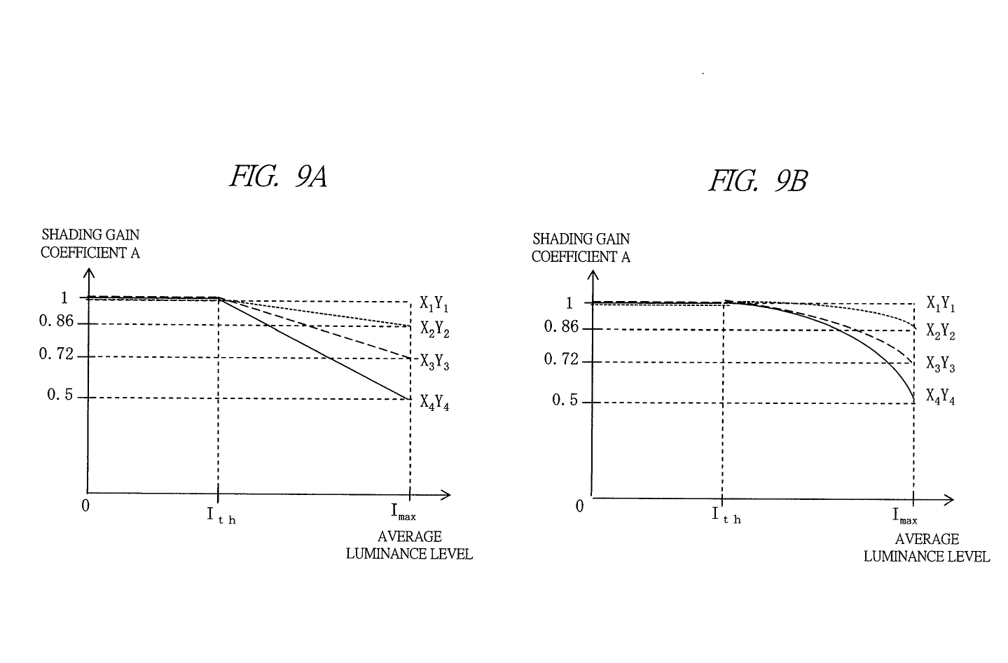

Examples of the shading gain coefficients a₁ output from the shading control signal storage 202 and the shading gain coefficients a₂ calculated by the shading circuit 204 are described with reference to FIG. 9A. X₁Y₁ to X₄Y₄ represent coordinates of pixels on the display panel (refer to FIGS. 2A to 2C). When the calculated average luminance level of the input video signal is higher than the predetermined threshold Iₜₕ, the shading gain coefficients a₁ and a₂ are decreased to be smaller than 1. These shading gain coefficients a₁ and a₂ are decreased as the coordinates are positioned closer to a peripheral portion on the display panel.

Also, when the calculated average luminance level of the input video signal is lower than the predetermined threshold Iₜₕ, the values of the shading gain coefficients a₁ and a₂ are set to 1 (that is, the shading process is stopped).

In FIG. 9A, the shading gain coefficients a₁ and a₂ are linearly attenuated over the calculated average luminance levels Iₜₕ to Iₘₐₓ of the input video signal. Alternatively, in consideration of a human visual feature, the coefficients may be attenuated in a non-linear manner as depicted in FIG. 9B. Note that the values of the shading gain coefficients are presented by way of example only, and are obtained by multiplying the values in FIGS. 2B and 2C together.

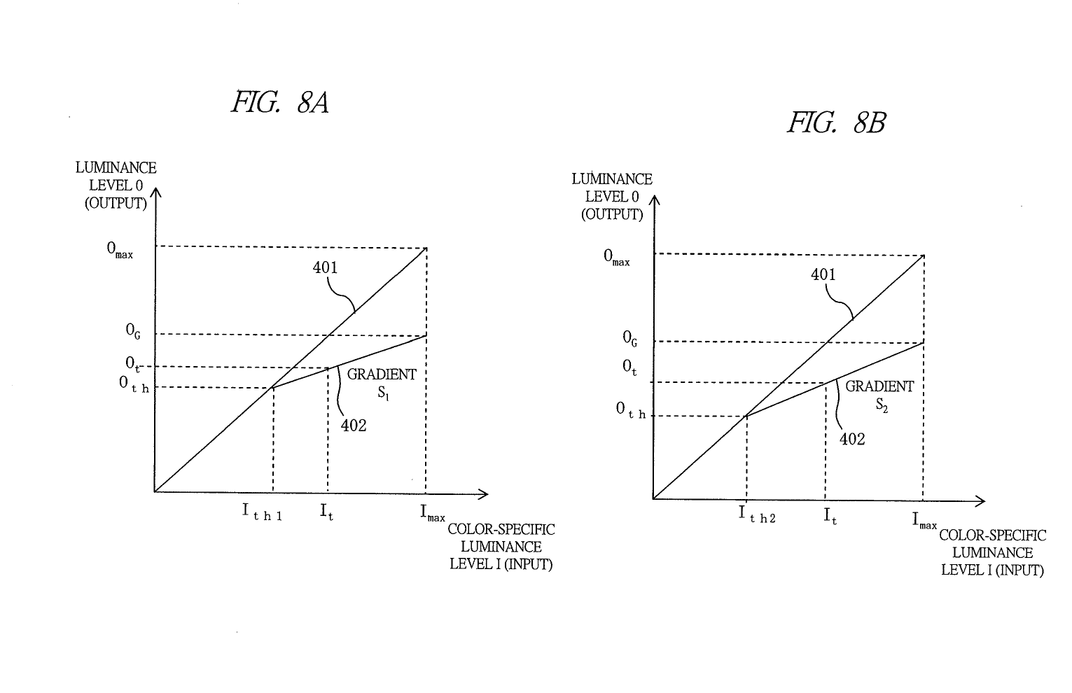

The arithmetic operation circuit is described with reference to FIGS. 8A and 8B. In FIGS. 8A and 8B, the X axis represents a luminance level I of an input video signal, and the Y axis represents a luminance level O of an output video signal. Iₜₕ and Oₜₕ are the above-described predetermined thresholds (Iₜₕ=Oₜₕ), and the luminance of the input video signal is desired to be decreased when the luminance level exceeds the predetermined threshold. Thus, as represented by a characteristic 402, its gradient S is smaller than that of a characteristic 401. The gradient S of the characteristic 402 is calculated by Equation 1 below. Also, a luminance level Oₜ of an output video signal after shading when the luminance level of the input video signal is higher than the predetermined threshold Iₜₕ is calculated by Equation 2 below, and an output luminance level O_{G} when the input luminance level is Iₘₐₓ is calculated by Equation 3 below. By this means, O_{G} is calculated from the maximum input luminance level Iₘₐₓ and the shading gain coefficient A (hereinafter, a shading gain coefficient directly used for calculating an output video signal is referred to as A), the gradient S is obtained by using Equation 1 below, and then Oₜ is determined by using Equation 2 below.

$$\begin{matrix}S = \frac{{O}_{G} - {O}_{th}}{{I}_{max} - {I}_{th}} & Equation 1 \\ {O}_{t} = {O}_{th} + S ( {I}_{t} - {I}_{th} ) & Equation 2 \\ {O}_{G} = A \cdot {I}_{max} & Equation 3\end{matrix}$$

Although only one type of the predetermined threshold is provided in FIGS. 8A and 8B, a plurality of thresholds can be provided to make the luminance level of the output variable in a stepwise manner.

In the present invention, the average luminance level of each pixel is an average of the average luminance levels of R, G and B making up pixels (obtained by dividing a total of the average luminance levels for R, G and B by 3). Thus, in FIGS. 8A and 8B, a first threshold Iₜₕ₁ is set to be higher than a second threshold Iₜₕ₂. Accordingly, as for the gradient, the gradient S₁ is smaller than the gradient S₂. However, the average luminance level of each pixel is not meant to be restricted to this, and may be a total of the average luminance levels of R, G and B making up pixels (R+G+B). In this case, the second threshold Iₜₕ₂ is set to be higher than the first threshold Iₜₕ₁.

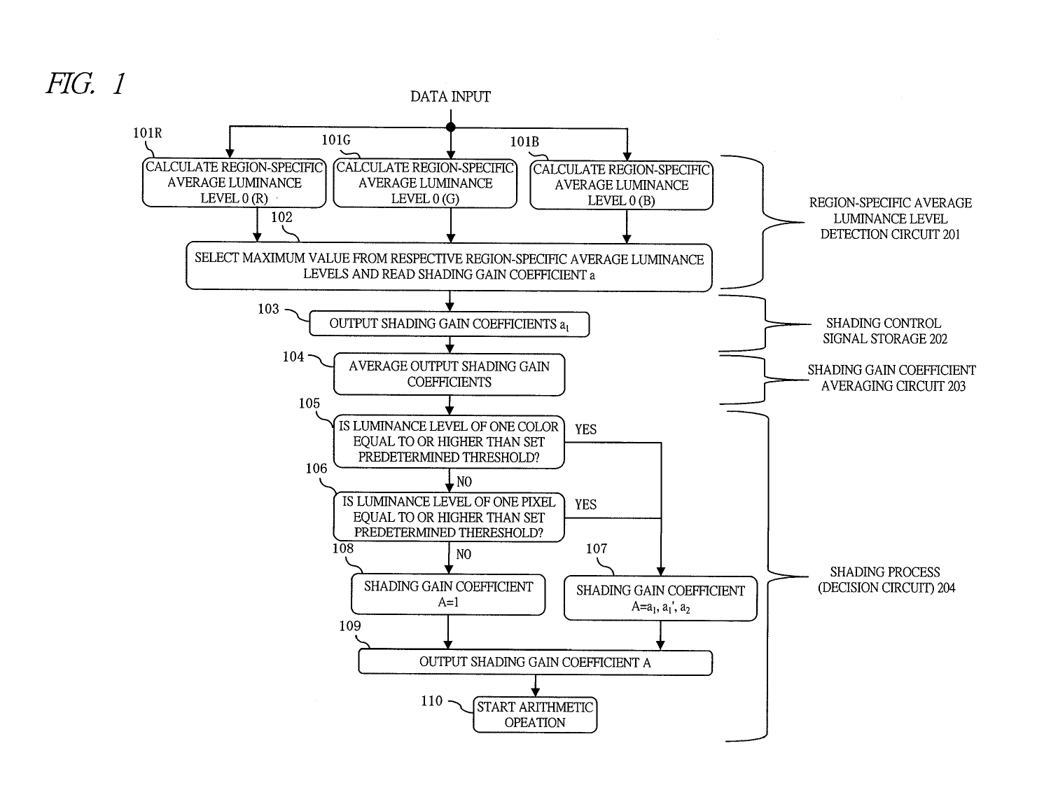

FIG. 1 is a diagram of an operation process flow in the embodiment of the present invention depicted in FIG. 5. Based on an input video signal, the region-specific average luminance level detection circuit 201 calculates a region-specific average luminance level of each color (steps 101R, 101G and 101B), and selects a maximum value from the average luminance levels calculated for the colors (step 102). Then, from the average luminance levels selected in the shading control signal storage 202, shading gain coefficients a₁ are output (step 103), and the shading gain coefficients a₁ calculated from the respective regions are then averaged (step 104) to calculate the shading gain coefficients a₁′. In this manner, a difference in luminance at a boundary portion among the regions is prevented.

The shading gain coefficients a₁′ obtained through averaging and the shading gain coefficients a₂ calculated through interpolation are input to the shading circuit 204. In a decision circuit in the shading circuit 204, when the maximum luminance level of the input video signal for each color is higher than a first threshold, shading gain coefficients a₁, a₁′, a₂ and others calculated for each relevant pixel are selected as shading gain coefficients A at step 107. When the maximum luminance level of each color is lower than the first threshold, a luminance level of one pixel is determined at step 106, and when the luminance level is higher than a second threshold, shading gain coefficients a₁′ and a₂ calculated for each relevant pixel are selected as shading gain coefficients A at step 107. When the luminance level is lower than the second threshold, 1 is output to an arithmetic operation circuit as a shading gain coefficient A at step 108. Here, the first threshold may be equal to the second threshold.

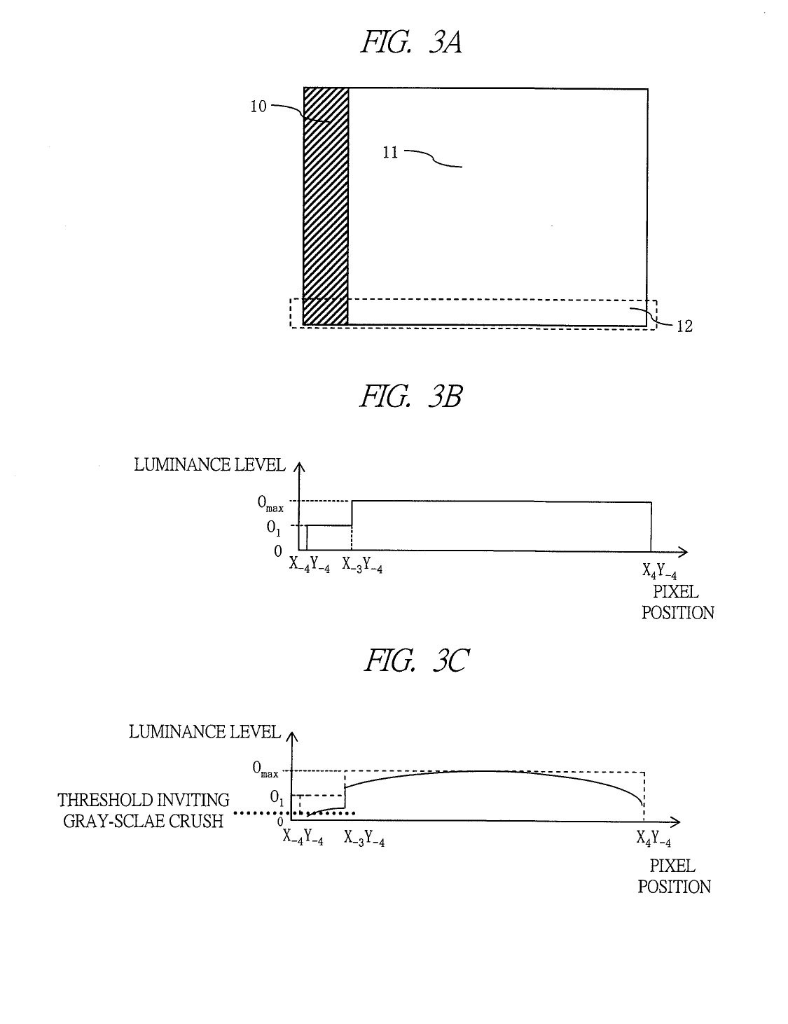

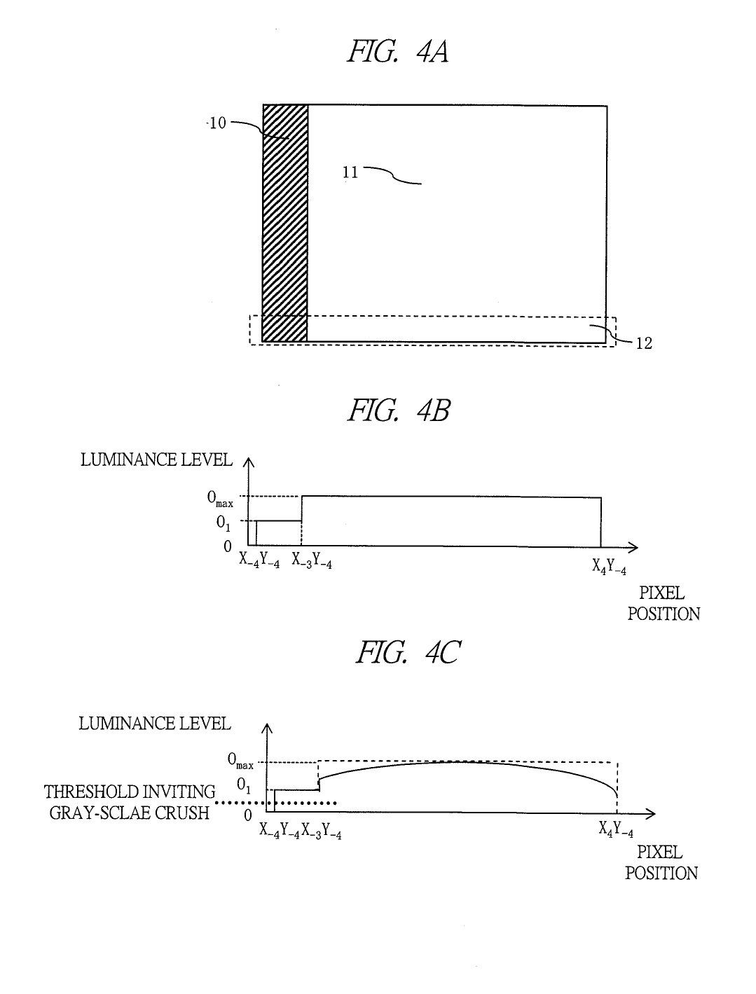

As described above, according to the present embodiment, even when a video signal as depicted in FIG. 4A is input, the control of stopping the shading operation in the low-luminance region 10, that is, a region between X₄Y₄ and X₄Y₃ as shown in FIG. 4C can be performed, and the deterioration in image quality due to gray-scale crush in the low-luminance region can be prevented. Note that FIGS. 4A and 4B are equivalent to FIGS. 3A and 3B, respectively.

On the other hand, the shading operation can be operated even when an input video signal in which an average luminance level of only one color among R, G and B making up pixels in each region is high but an average luminance level is low as an entire display panel is input. Therefore, the luminance of the screen center portion can be increased without increasing power consumption, and high-quality video with excellent contrast can be provided.

In the description of the present embodiment, a PDP is taken as an example of a display panel of a self-luminous type. However, the present invention can be similarly applied to an FED, EL and LED as described above. Also, the present invention can be similarly applied to a product that is not a self-luminous type such as an LCD.

What is claimed is:

1. A video display apparatus performing a shading process for decreasing a luminance level of a peripheral portion on a display panel with respect to a luminance level of an input image signal, the apparatus comprising:
a region-specific average luminance level detection circuit which divides a display region of the display panel into plural regions and detects an average luminance level of each region; and
a shading circuit which changes a shading gain coefficient representing a decreasing ratio in accordance with the average luminance level of each region detected by the region-specific average luminance level detection circuit.

2. The video display apparatus according to claim 1, wherein
the shading process is stopped in a display panel region in which the average luminance level detected by the region-specific average luminance level detection circuit is lower than a first threshold.

3. The video display apparatus according to claim 2, wherein
the average luminance level of each region is a maximum value of average luminance levels of colors making up pixels in the relevant region.

4. The video display apparatus according to claim 2, wherein
the average luminance level of each region is an average value of average luminance levels of colors making up pixels in the relevant region.

5. The video display apparatus according to claim 3, wherein
when the average luminance level of each region does not exceed the first threshold, the shading process is performed if the input video signal has a luminance level exceeding a second threshold.

6. The video display apparatus according to claim 5, wherein
when a luminance level of one color of the input image signal does not exceed the second threshold, the shading process is performed if a luminance level of one pixel of the input image signal exceeds a third threshold.

7. The video display apparatus according to claim 6, wherein
the second threshold is higher than the third threshold.

8. The video display apparatus according to claim 4, wherein
an average of shading gain coefficients calculated from average luminance levels in adjacent four regions including one of pixels corresponding to four corners of the region is taken as a shading gain coefficient corresponding to the relevant pixel.
